(19) United States
(12) Patent Application Publication
(10) Pub. No.: US 2011/0111209 A1
(43) Pub. Date: May 12, 2011

(54) FURNACE LINING

(75) Inventor: Stephen Stewart Weiss, London (GB)

(73) Assignee: ELMELIN LIMITED, London (GB)

(21) Appl. No.: 12/935,433

(22) PCT Filed: Mar. 31, 2009
(86) PCT No.: PCT/GB2009/000853

§ 371 Date: Dec. 17, 2010

(30) Foreign Application Priority Data
Apr. 4, 2008 (GB) 0806259.8

(51) Int. Cl. F27D 1/00; B32B 15/04; F27D 1/16

(52) U.S. Cl. 428/324; 428/335; 428/336; 427/230

(57) ABSTRACT

This invention relates to a lining for induction furnaces, and more specifically a lining for coreless induction furnaces. A flexible lining material (10) for lining an induction furnace (1) has a laminated structure comprising metal foil (12) and at least one heat-resistant supporting layer (14). The incorporation of a very thin metallic foil layer (12) in the lining material (10) creates a vapour barrier preventing vapours such as zinc from reaching the induction coil (4) of the furnace. The lining material (10) is designed so that the metal foil (12) is not significantly affected by the induction fields during the operation of the furnace.

### BACKGROUND

a. Field of the Invention

This invention relates to a lining material and method of lining a coreless induction furnace.

b. Related Art

Electrically powered induction furnaces and coreless induction furnaces in particular are widely used in foundries to provide the molten metal used to make castings.

Coreless induction furnaces typically comprise a refractory crucible inside a water-cooled induction coil. The inner face of the induction coil is usually covered by a thin layer of refractory plaster which is called the coil grout. To form the crucible, a former is placed temporarily inside the coil. Refractory sand is then rammed into the space between the coil grout and a cylindrical former and compacted to form the crucible.

It is known to provide a layer between the coil grout and the crucible to provide a slip plane between these surfaces so that movement can take place between these surfaces during the heating and cooling of the furnace, and to assist in the removal of the crucible at the end of its life. Generally this slip plane layer is formed from mica or laminates of mica and other high temperature materials.

Coreless induction furnaces can be used to melt a variety of metals, including metals with relatively low melting temperatures such as zinc and lead. When such metals are heated beyond their melt temperatures they often turn to vapour. These vapours sometimes have the ability to penetrate the crucible, and there is a danger that they will condense onto the water cooled induction coil and cause an electrical breakdown. In such circumstances there is a need to provide a layer between the molten metal and the induction coils that will act as an effective vapour barrier to prevent metal vapour, for example zinc vapour, from reaching the coils.

This layer must also withstand the maximum temperatures likely to be encountered in that area of a furnace, which could be as high as 550° C.-950° C., as well as remaining largely unaffected by the induction field.

It is known in the art to provide a metallic layer between the crucible and the induction coils in a furnace. These metal layers are typically formed by a rigid casing, for example GB 2161591 or EP 0439900. However, these casings are made specifically for each furnace and are generally of a complicated design to avoid the problems of heating in the induction field. JP 08303965 describes a 1 mm thick stainless steel plate that can be wrapped into a coil, or two overlapping plates, which are placed between the induction coil of a furnace and the crucible. However, the thickness of the stainless steel plate is such that it is likely to be heated excessively by the induction field and would melt if used in higher power furnaces. Additionally, this heating of the 1 mm thick stainless steel plate or plates would seriously reduce the efficiency of the furnace. Furthermore, the plate or plates provided between the coil and the coil grout are permanently installed in the furnace.

Therefore, the problem to be solved is to provide an effective vapour barrier that is substantially not affected by induction fields and which may be easily installed in existing induction furnaces.

### SUMMARY OF THE INVENTION

Aspects of the invention are specified in the independent claims. Preferred features are specified in the dependent claims.

The metal foil within the flexible lining material is impervious to the penetration of metal vapour and so will prevent harmful metal vapours from condensing onto the induction coil.

The use of an extremely thin layer of non-magnetic stainless steel foil within the lining material makes this vapour barrier substantially un-affected by the induced currents produced by the furnace. As a result the flexible lining material of the invention will not become substantially heated by the induction field generated by the furnace and therefore will not significantly reduce its operating efficiency.

Also, the flexible lining material of the invention is designed to be a consumable product that can be replaced every time that a new crucible is installed into the furnace.

### BRIEF DESCRIPTION OF THE DRAWINGS

The invention will now be further described, by way of example only and with reference to the accompanying drawings, in which:

FIG. 1 shows a coreless induction furnace, partly in section;

FIG. 2 is a cross-section through the wall of the furnace of FIG. 1, not to scale;

FIG. 3a shows the suggested limits of the use of a lining material with a foil layer of thickness 0.05 mm in an induction furnace which operates at 400 Hz. At the present time, the lining material is only recommended for use in furnaces falling within the non-shaded region;

FIG. 3b shows the suggested limits of the use of a lining material with a foil layer of thickness 0.025 mm in an induction furnace which operates at 400 Hz. At the present time, the lining material is only recommended for use in furnaces falling within the non-shaded region;

FIG. 4 is an illustration of the application of strips of the lining material of the present invention to a wall of a furnace; and

FIG. 5 is a detail showing the overlap of the strips of lining material of FIG. 4.

### DETAILED DESCRIPTION

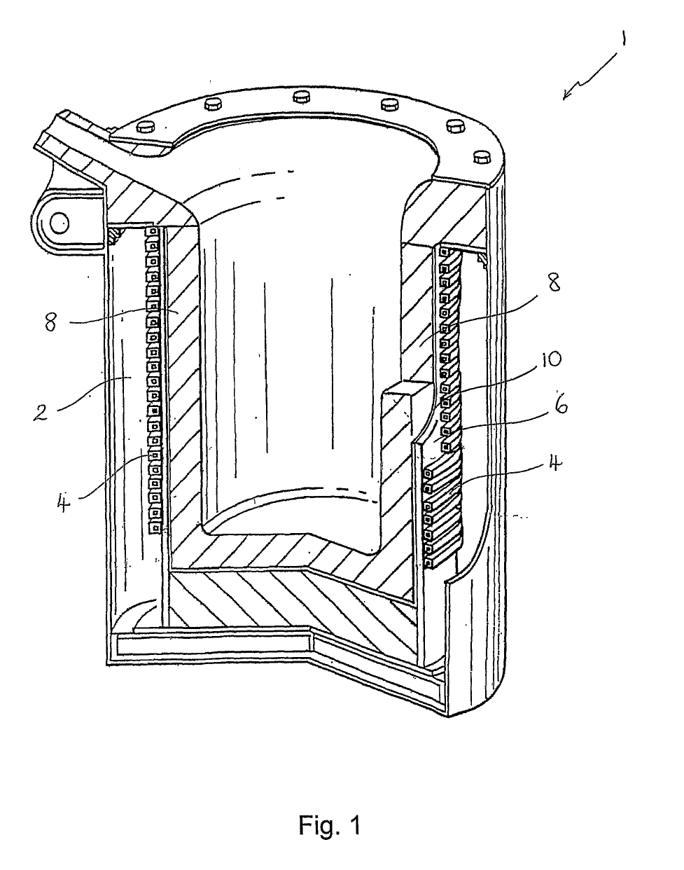

FIG. 1 shows a typical coreless induction furnace 1 comprising an outer jacket 2, with a water-cooled induction coil 4 within the jacket. The coil 4 is generally made of copper. On the inside of the coil 4, there is a thin layer of refractory plaster, usually 8-10 mm thick, called the coil grout 6 which forms a smooth surface on the inside of the furnace 1, as well as protecting the coil 4.

To form a crucible 8, a cylindrical former (not shown) typically of a diameter 200-250 mm smaller than the coil 4 is temporarily placed inside the furnace and refractory sand is rammed into the space between the coil grout 6 and the former. The refractory sand is then compacted in a conventional manner.

A lining material 10 is provided between the coil grout 6 and the crucible 8, the construction and function of which will be described below.

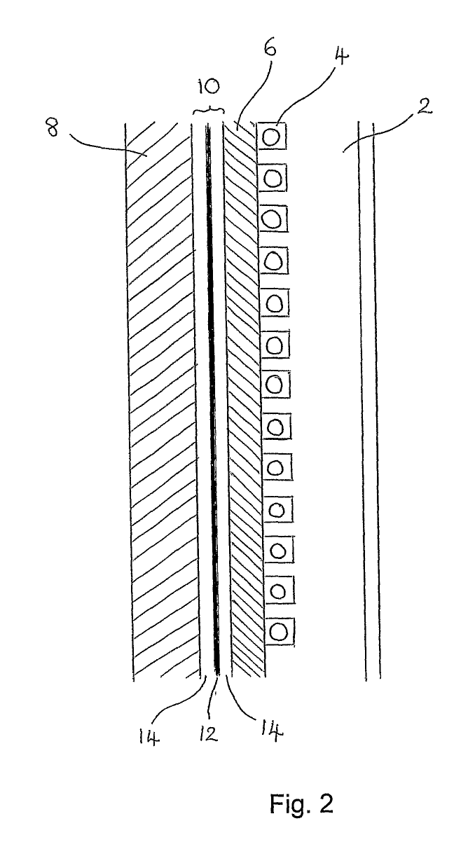

The lining material 10 is a laminated structure comprising a thin metallic foil layer 12 interposed between two support layers 14, as shown in FIG. 2.

As well as acting as a physical support for the thin metallic foil 12, the support layers 14 are heat-resistant and electrically insulating. The support layers 14 may be made from mica, high temperature insulating paper, a glass-fibre mat, or other similar material.

The metallic foil 12 is made from a metallic material that is substantially not affected by induced currents. This does not exclude the presence of some induced currents in the metal; however, any currents in the metal should not cause the metal to heat up significantly. If the metal were to heat up significantly, it could melt. Even if it did not melt, significant heating of the metal would reduce the efficiency of the furnace and have other adverse effects.

This result can be achieved through careful choice of the metal from which the foil is made and the thickness of the foil layer.

The foil 12 should be made of a metal with low electrical conductivity and permeability. This reduces the amount of heating the metal experiences when placed in an induction field. Additionally the metal should have a high melting point, be substantially impervious to vapour penetration and be capable of being bonded to a supporting substrate. Ideally the foil is non-magnetic. It has been found that stainless steel can be used to form an effective foil layer. There are many different forms of stainless steel, however most have melting points around 1400° C. Additionally the nickel content of the stainless steel affects its magnetic properties, and austenitic stainless steel in particular, with relatively high nickel content, is non-magnetic. It is therefore preferable to make the foil layer 12 from austenitic stainless steel.

The metallic foil 12 in the lining material 10 should be as thin as possible to reduce the effect of any induced currents in the metal. There are a number of factors that are important in determining the maximum thickness of foil 12 that can be used in a particular furnace 1. These factors include the frequency of the current in the induction coil 4; the electrical power generated by the coil 4; and the diameter of the furnace, all of which determine the strength of the induction field and the extent to which it will couple with the metallic foil. Other important factors are the melt temperature of the metal in the crucible and the thermal conductivity of the refractory used to make the crucible.

Generally, the stronger the induction field and the higher the frequency of the current, the thinner the metallic foil 12 should be to withstand possible heating effects. An important parameter is the power absorbed by the foil 12 as a result of being positioned in a strong electromagnetic field. Trials have shown that in a furnace with an induction coil 4 of 1.6 m diameter and a depth of 1.6 m, operating at 2,400 kW and 50 Hz, only very slight heating of 0.05 mm thick foil 12 occurred.

Previously, induction furnaces generally operated at a mains frequency of about 50 Hz. However, in recent years, medium frequency induction furnaces that operate at 150-400 Hz are becoming common. The induction field produced by these higher frequencies is more able to heat up the metal foil 12 than the field generated by a mains frequency furnace. Consequently, in order to counter this deleterious affect, the thickness of the metal foil 12 used in the lining material 10 has to be carefully chosen. Tests have indicated that the desired thickness of a stainless steel foil 12 is no more than 0.05 mm for the more powerful mains frequency and most medium frequency furnaces. In very powerful medium frequency and moderately powerful high frequency furnaces it is preferable to reduce the thickness further to about 0.025 mm. If too thick a foil layer 12 is used the metal may heat up excessively and may overload the water cooling system in the furnace. The foil may also heat to such an extent that the stainless steel would melt and therefore no longer act as a vapour barrier.

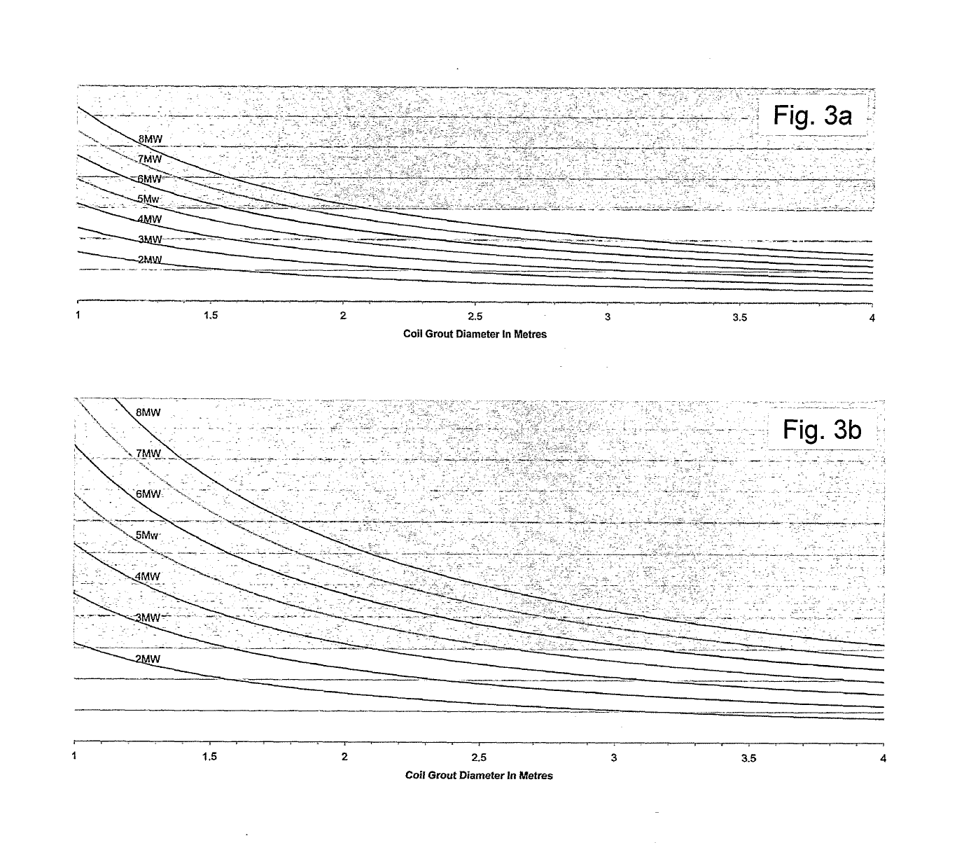

FIGS. 3a and 3b illustrate the suitability of lining materials 10 having different thicknesses of stainless steel foil 12 for a range of coreless induction furnaces of varying power, frequencies and sizes. FIG. 3a shows the suggested limit of operation for a lining material 10 having a 0.05 mm thick foil layer 12 in an induction furnace that operates at 400 Hz. The results show that this lining material should be suitable for a furnace with a grout diameter of 2 m, as long as its power is 3.5 MW or less. FIG. 3b shows similar results for a lining material 10 having a metallic foil layer 12 with a thickness of only 0.025 mm. From these results it is suggested that this thinner material could be used in the previous example of a furnace with a grout diameter of 2 m, operating at a power of up to 7.5 MW.

As shown in FIGS. 2 and 5, the thin metallic foil layer 12 is bonded to supporting layers 14. The metallic foil 12 may be bonded to the support layers 14 using any suitable means, for example adhesive. In a preferred embodiment, a supporting layer 14 is provided on both sides of the foil 12, however, a supporting layer 14 may be provided on only one side of the foil 12. When provided on both sides, the supporting layers 14 may be made of the same material or may be made from different materials.

To achieve a very thin foil layer 12 it may also be possible to coat the face of a supporting layer 14 with metal using, for example, vapour deposition techniques.

This would allow foil thicknesses of substantially less than 0.02 mm to be achieved.

For reasons of cost, it is becoming increasingly desirable for iron foundries to be able to melt some galvanised scrap iron. However, the boiling point of zinc is below the melting temperature of iron and consequently zinc vapour is likely to be produced during the operation of the furnace. Zinc vapour can penetrate through the refractory sand forming the crucible wall, and can penetrate through the coil grout. If it comes into contact with the water cooled coil, it may condense leading to a short circuiting of the coil. This is a particular problem when the furnace is switched off as the walls of the crucible will shrink as they cool and cracks will form. If the crucible is not perfectly sealed the zinc vapours will easily pass through the walls and eventually to the induction coil.

The lining material 10, and in particular the metallic foil 12, acts as a barrier to the zinc vapour. It can also act as a barrier to other vapour, for example cadmium or lead vapour, migrating from the molten metal in the crucible 8 to the induction coils 4.

The lining material 10 may also provide a barrier to hot metal escaping through cracks in the crucible wall. As with zinc vapour, it is highly undesirable for molten metal to make contact with the coil grout 6 or with the coil 4 as this can lead to catastrophic damage to the coil 4 and the furnace 1.

Because the lining material 10 contains a metallic foil 12, it may also be used to provide an early indication of a potential breakout of molten metal to the coil which, should it occur, could result in a catastrophic breakdown. Generally, the melt in the crucible 8 is connected to earth via a metal electrode probe, which projects through the floor of the crucible 8. By also attaching the metallic foil 12 in the lining material 10 to the earth circuit, were the melt to touch the foil 12, a circuit would be created which would allow the furnace 1 to be instantly shut down.

In addition to the functions and advantages described above, the lining material 10 may also act as a “freeze plane” or physical barrier such that any liquid or vapour passing through the crucible wall 8 is effectively blocked by the foil so that it condenses or solidifies before reaching the induction coil 4.

The lining material 10 can also provide a slip plane between the crucible 8 and the coil grout 6. In this case, the slip-plane lining material aids the removal of the crucible 8 when it needs to be replaced. Typically, a refractory crucible 8 may need to be replaced every month in an iron foundry, mainly due to wear of the crucible walls 8 by the molten metal being continually stirred by the induction fields.

Another important advantage is that the thinness of the metal foil layer 12 results in the lining material 10 being flexible. The lining material is able to be manipulated by hand and will substantially conform to the shape of the furnace walls when used to line an induction furnace 1. The lining material 10 may also be formed in continuous sheets and wound into rolls for ease of supply, storage and use.

The presence of a supporting layer 14 on both sides of the metallic foil 12 also makes the material easy to handle so that it is quick and easy to line a furnace 1 before the crucible 8 is formed. The lining material 10 can be used as a consumable with the furnace 1 being re-lined each time a new crucible 8 is formed. This is usually necessary because slip-plane lining material is often damaged when the old crucible is being removed.

The lining material 10 can also be applied to any size or shape of furnace. The lining does not have to be specially machined or shaped to fit in a particular furnace. Additionally, as the lining is not permanently installed in the furnace, maintenance costs are reduced.

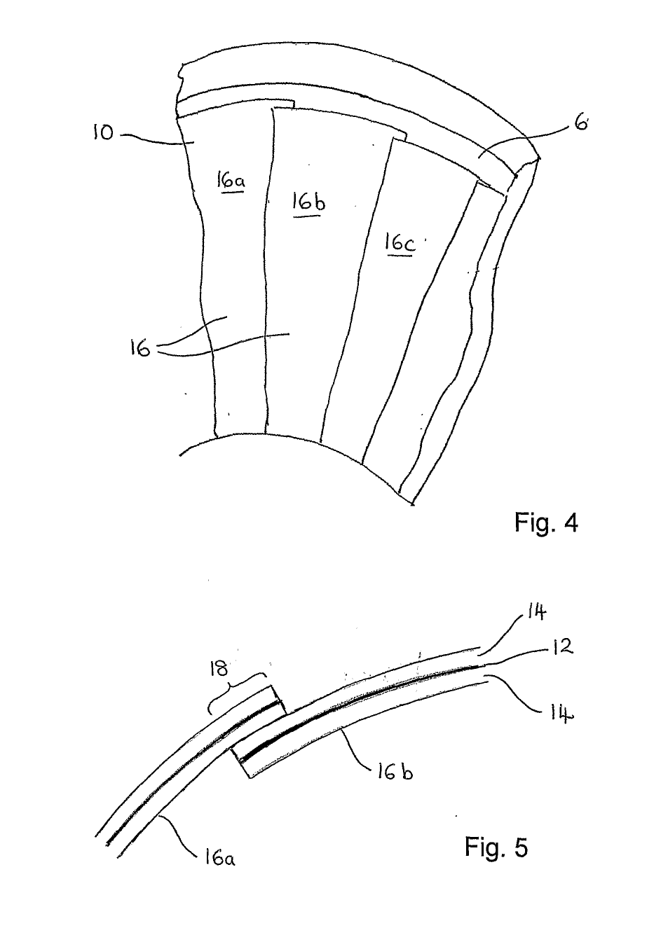

The process of lining a coreless induction furnace 1 with the lining material 10 is relatively easy. FIG. 4 shows how a furnace can be lined using a lining material 10 in accordance with the invention. The lining material 10 is provided in strips 16, which may be cut from a longer roll of material (not shown). The lining material 10 is located on the inner surface of the coil grout 6, and is typically fixed in place using suitable means such as adhesive. Each strip 16a, 16b, 16c etc of lining material 10 is typically laid vertically up the inner surface of the furnace wall in contact with the coil grout 6. As each subsequent strip 16 is laid it is positioned so that it overlaps the previous adjacent strip. This overlap 18, shown most clearly in FIG. 5, performs two functions. It means that a continuous vapour barrier is formed around the circumference of the furnace 1 as the foil 12 within each strip 16 will overlie the foil 12 in the adjacent strip at the overlap 18. The overlap 18 also means that there is at least one support layer 14 between the layers of foil 12 within adjacent strips 16a, 16b. The support layers 14 are electrically insulating and therefore prevent electrical current passing from one strip 16 to the next, in a circumferential direction around the furnace 1. A continuous conductive path around the furnace 1 must be avoided as otherwise the metallic foil 12 would form a secondary circuit in its own right. For illustration purposes, the lining material 10 in FIG. 4 is shown as not extending the full height of the furnace walls. However, the lining material 10 would in practice be laid such that it extends initially beyond the top of the furnace walls and then would be cut to length once in position. Because the lining material 10, and in particular the metallic foil layer 12, is thin, the lining material 10 may be cut with a knife or scissors.

The lining material of the present invention therefore provides a lining for a coreless induction furnace that is easy to install. The incorporation of a very thin metallic foil layer in the lining material creates a vapour barrier preventing vapours such as zinc from reaching the induction coil of the furnace. Although induction furnaces by their nature are used to melt metals, careful selection of the metal used to make the foil and the thinness of the foil reduces the heating effect of the induction field to such an extent that the foil is not significantly affected by the operation of the furnace. Additionally, as the lining material is substantially unaffected by the induced currents, it does not become substantially heated by the induction field and therefore does not significantly reduce the operating efficiency of the furnace.

The lining material of the present invention offers a number of other important advantages over previous lining systems. The lining material is very thin and therefore flexible and can be supplied in rolls. It is also easy to install and can be used in any furnace. It is relatively inexpensive and can be used as a consumable and replaced each time a new crucible is formed.

1. A flexible lining material for lining a coreless induction furnace, the lining material having a laminated structure comprising metal foil and at least one heat-resistant and electrically insulating supporting layer.

2. A flexible lining material as claimed in claim 1, wherein both faces of the foil are covered by a heat-resistant and electrically insulating supporting layer.

3. A flexible lining material as claimed in claim 1, wherein one face of the foil is covered by a heat-resistant and electrically insulating supporting layer.

4. A flexible lining material as claimed in any preceding claim, wherein the supporting layer is mica.

5. A flexible lining material as claimed in any of claims 1 to 3, wherein the supporting layer is a high temperature insulating paper sheet.

6. A flexible lining material as claimed in any of claims 1 to 3, wherein the supporting layer is a glass-fibre web or sheet.

7. A flexible lining material as claimed in any preceding claim, wherein the metal foil is stainless steel.

8. A flexible lining material as claimed in claim 7, wherein the metal foil is austenitic stainless steel.

9. A flexible lining material as claimed in any preceding claim, wherein the metal foil has a thickness of less than 0.5 mm.

10. A flexible lining material as claimed in any preceding claim, wherein the metal foil has a thickness of less than 0.2 mm.

11. A flexible lining material as claimed in any preceding claim, wherein the metal foil has a thickness of between 0.06 mm and 0.02 mm.

12. A flexible lining material as claimed in any preceding claim, wherein the metal foil has a thickness of substantially 0.05 mm.

13. A flexible lining material as claimed in any preceding claim, wherein the metal foil has a thickness of substantially 0.025 mm.

14. A method of lining a coreless induction furnace, the furnace having an induction coil extending around a perimeter of the furnace and the coil being covered by a layer of coil grout on an inner surface, the method comprising the steps of:
locating a first section of lining material over a part of the surface of the coil grout;
locating a second section of lining material over a second part of the surface of the coil grout such that a region of the second section overlaps a region of the first section; and
locating further sections of lining material in the same way such that the whole of the surface of the coil grout is covered;
wherein the lining material has a laminated structure comprising metal foil and at least one heat-resistant and electrically insulating supporting layer and the sections are arranged such that the supporting layer electrically insulates the metal foil in one section from the metal foil in an adjacent section.

15. A method of lining a coreless induction furnace as claimed in claim 14, wherein the lining material is provided on a roll, and the method comprises the steps of:
unrolling a length of lining material from the roll;
locating the length of lining material over a part of the surface of the coil grout; and
cutting the lining material to length.
